(19) United States
(12) Patent Application Publication
(10) Pub. No.: US 2025/0130867 A1
(43) Pub. Date: Apr. 24, 2025

(54) PROVIDING RESILIENCE IN DISTRIBUTED SYSTEMS

(71) Applicant: Dell Products L.P., Round Rock, TX (US)

(72) Inventors: BORIS SHPILYUCK, Ashdod (IL); MAXIM BALIN, Gan-Yavne (IL); IGOR DUBROVSKY, Beer Sheva (IL); NISAN HAIMOV, Beer Sheva (IL)

(21) Appl. No.: 18/491,166

(22) Filed: Oct. 20, 2023

(51) Int. Cl. G06F 9/50; H04L 9/00; H04L 67/10

(52) U.S. Cl. CPC G06F 9/5072; H04L 9/50

(57) ABSTRACT

Methods and systems for managing operation of a distribute system are disclosed. To manage the distributed system, a distributed ledger may be used to track the condition of the system. The distribute ledger may be managed in accordance with a consensus based approach. The consensus based approach may limit the impact of compromised entities by reducing the ability of the compromised entities from introducing malicious data into the data upon which management decision are made. Additionally, the distributed ledger may provide a shared understanding the condition of the distributed system across the distributed system.

### FIELD

Embodiments disclosed herein relate generally to device management. More particularly, embodiments disclosed herein relate to systems and methods to manage operation of devices.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a block diagram illustrating an example of infrastructure in accordance with an embodiment.

FIGS. 2B-2C show data flow diagrams in accordance with an embodiment.

FIGS. 3A-3B show flow diagrams illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems of a distributed system. To manage the data processing systems, a distribute ledger may be maintained to provide a consistent view of the condition of the distribute system.

The ledger may be populated with information regarding the distributed system, and may be managed in accordance with a proof of stake management system. To add information to the ledger, the proof of stake mechanism may be used to vet proposed transactions for the distributed ledger. If approved, instances of the distributed ledger across the data processing system may be updated.

To manage the data processing systems, groups of data processing systems may be assigned to orchestrators for management purposes. If an orchestrator is unable to continue to manage the assigned data processing systems, the data processing systems may be reassigned to another orchestrator for management. The new orchestrator may, by virtue of access to an instance of the distribute ledger, may have access to the information necessary to make management decisions regarding the data processing systems.

By doing so, embodiments disclosed herein may improve the likelihood of desired computer implemented services being provided by improving the likelihood of successful management of the data processing systems. The likelihood of successful management may be improved by reducing the likelihood of malicious activity from impacting management of the data processing systems by using a consensus mechanism to come to a shared understanding of the condition of the distributed system. Additionally, the likelihood of successful management may also be improved by facilitating rapid changes in management of data processing systems. The shared understanding gleaned by the distributed ledger may allow any device to operate as an orchestrator.

In an embodiment, a method for managing resources of a distributed system is provided. The method may include obtaining, by an orchestrator of the distributed, a proposed transaction for a distributed ledger that stores management data for the distributed system; participating, by the orchestrator, in a consensus process for the proposed transaction; in an instance of the participating where the proposed transaction is approved by orchestrators of the distributed system: updating, by the orchestrator, a local instance of the distributed ledger using the transaction to obtain an updated distributed ledger; identifying, by the orchestrator, unprocessed management data from the updated distributed ledger; obtaining, by the orchestrator and using the unprocessed management data, a workorder for a data processing system for the distributed system; updating, by the orchestrator and using the workorder, operation of the data processing system to obtain an updated data processing system; and providing, by the orchestrator and using the updated data processing system, computer implemented services.

The consensus process may be a blockchain process that utilizes a proof of stake mechanism for management of the distributed ledger.

The proof of stake mechanism may select at least a portion of the orchestrators to vote on the proposed transaction.

The votes cast by the portion of the orchestrators may be used to identify whether the orchestrators approved the proposed transaction.

The portion of the orchestrators may be selected at random from orchestrators, and the portion of the orchestrators is at least a majority of the orchestrators.

The proposed transaction may indicate reassignment of management of the data processing system from another orchestrator of the orchestrators to the orchestrator for management purposes.

The proposed transaction may indicate a change in condition of the data processing system.

The distributed system may include data processing systems including the data processing system, and each of the orchestrators may be tasked with managing a subset of the data processing systems.

Each of the orchestrators may maintain a separate local instance of the distributed ledger.

Each of the separate local instances of the distributed ledger may be eventually consistent with each other, and each of the local instances of the distributed ledger may include first data reflecting a condition of each data processing system of the distributed system and management assignments for the orchestrators, the management assignments may indicate the subset of the data processing systems each orchestrator is tasked with managing.

In an embodiment, a non-transitory computer readable media (e.g., a machine readable medium) is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

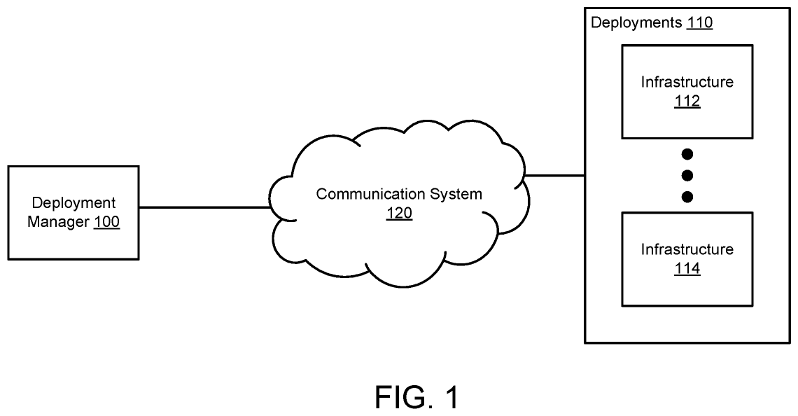

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, the system of FIG. 1 may include deployments 110. A deployment may include collections of various infrastructure 112, 114. Infrastructure (e.g., 112-114) may include any number of data processing systems (e.g., servers, edge devices, internet of things devices, data centers, etc.) that may provide all or a portion of the computer implemented services (e.g., cooperatively and/or independently). Different infrastructure and deployments may provide similar or different computer implemented services.

To provide the computer implemented services, the components of infrastructure of deployment 110 may take on various roles that contribute in different manners to the computer implemented services. For example, the roles may include data collection roles, management roles, etc.

When performing a given role, various information regarding deployment 110 may be taken into account. For example, to perform a management role, a data processing system may use information regarding the condition and operation of other data processing systems to decide how to manage other data processing systems. The management decision made using the information may, for example, result in changes to configurations of, software hosted by, and/or other aspects of the data processing system. These changes may adapt the operation of the data processing system changing conditions.

However, to make and use such decisions, both the data upon which the decisions is made must be available and the devices that use the data to make the decisions must be available. For example, if a decision making device uses stale data regarding the condition of a data processing system to make a decision, the decision may be inappropriate and result in the data processing system operating in a less and/or undesirable manner. Similarly, if a decision making device is unavailable (e.g., temporarily or permanently), then such decision may not be made timely (e.g., to address changing conditions) and/or not at all. Consequently, the operation of the data processing system may become unaligned with respect to the current conditions of the data processing system and/or other devices of a distributed system.

If bad and/or no decision are made, then the operation of the data processing systems may not be updated overtime to adapt to change conditions. Consequently, the operation of the data processing system may become less desirable by virtue of this misalignment.

For example, consider a scenario where a data processing system is a member of a network environment experiencing communication issues that limits communication bandwidth. In its default mode of operation, the data processing system may liberally use communication bandwidth thereby misaligning its operation with the current conditions of the distributed system. To address the current conditions, the operation of the data processing system may be updated to reduce communication bandwidth usage to better align its operation with the current conditions. However, if information regarding the available communication bandwidth is stale and does not reflect the reduced bandwidth, decision making devices may not updated the operation of the data processing system to align it with the new communication bandwidth conditions. Likewise, if the decision making device is unavailable, the previous operation of the data processing system may continue thereby causing its operation to be unaligned with the current conditions.

In general, embodiments disclosed herein may provide methods, systems, and/or devices for managing operation of a distributed system. The operation may be managed using a data management framework. The data management framework may include standards which govern how management information is added to repositories of management information used to manage operation of the distributed system. The management information may include, for example, information regarding the condition of components of the distributed system, environments (e.g., network, physical) in which the components reside, management decision that have been previously made with respect to the components, actions previously taken to manage the components, and/or other types of information usable to manage the operation of a distributed system.

To facilitate access to the information, separate instances of the management information repositories may be maintained by the components of the distributed system. Each component may separately maintain their respective instance by modifying the information in accordance with decisions regarding the content of the management information repositories.

The decision regarding the content of the management information repositories may be made using a consensus system, such as a blockchain driven distributed ledger. The blockchain driven distributed ledger may utilize a proof of stake based algorithm to modify the content of the distributed ledger. Thus, using the blockchain based approach, immutable and verifiable instances of the ledger may be generated and used throughout the distributed system.

The content of the distributed ledger may be used to make management decisions. For example, changes to operation of the components of the distributed system, changes to hierarchical management of the components, and/or other changes to the operation and management of the components may be made based on the content of the distributed ledger

By doing so, each component of the distributed system may have a consistent view of the state of the system. Accordingly, should any components of the system fail, the failed component may be replaced with another component that already has access to a system level view. Accordingly, bottlenecks, single points of system wide failures, and/or other undesired characteristics of centralized systems may be mitigated.

To provide the above noted functionality, the system of FIG. 1 may include deployment manager 100, deployments 110, and communication system 120. Each of these components is discussed below.

Deployment manager 100 may cooperatively manage components of deployments 110 with the components. For example, deployment manager 100 may enable administrators or other persons to define and deploy management policies to management entities of deployments 110. The management policies may define action to be performed based on the content of a distributed ledger maintained by deployments 110. Orchestrators or other management entities of deployments 110 may use the policies to identify corresponding management actions to perform to manage deployments 110.

Deployments 110 may include any number of collections of infrastructure 112-114. The infrastructure may provide various computer implemented services. Different infrastructure may include different types and/or numbers of data processing systems that may perform different roles (e.g., management, members, etc.).

Provide the computer implemented services, management entities may use the policies and distribute ledger to modify operation of deployments 110 over time. To do so, each of the management entities may (i) host an instance of the distributed ledger, (ii) participate in updating of the distributed ledger, and (iii) use automation engines or other frameworks to update the operation of other components of deployments 110 based on the ledger and corresponding policies.

While illustrated as being separate from deployments 110, the functionality of deployment manager 100 may be performed by any of the components of deployments 110. For example, deployment manager 100 may be implemented using a distributed management framework. The management framework may perform the functionality of deployment manager 100, discussed herein.

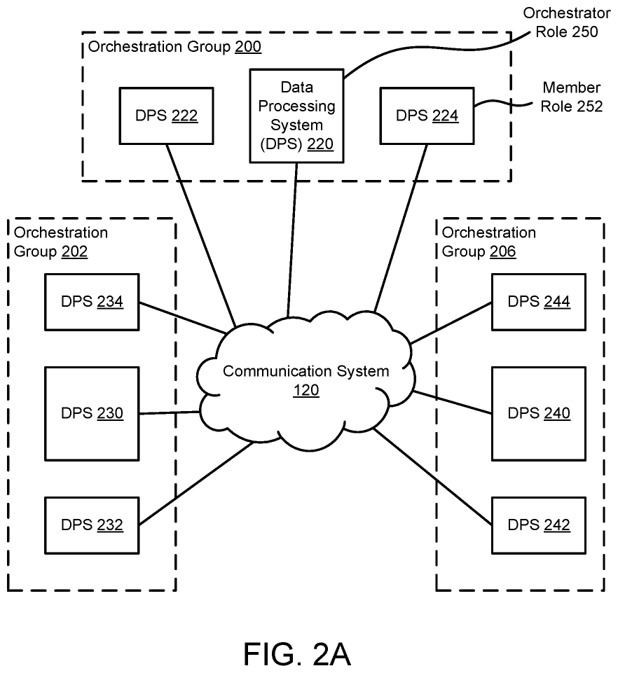

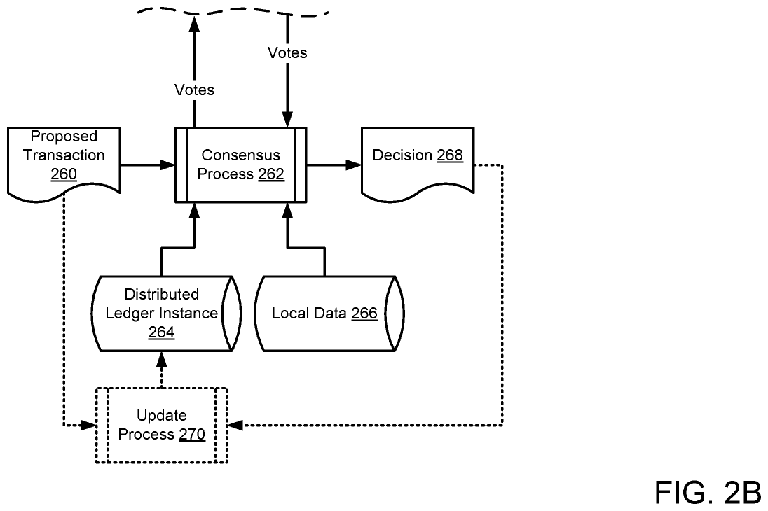

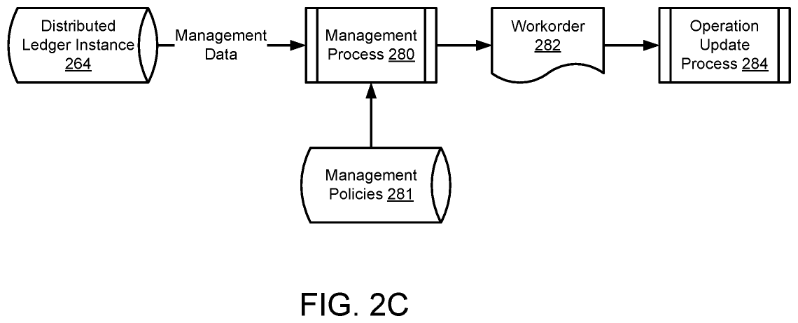

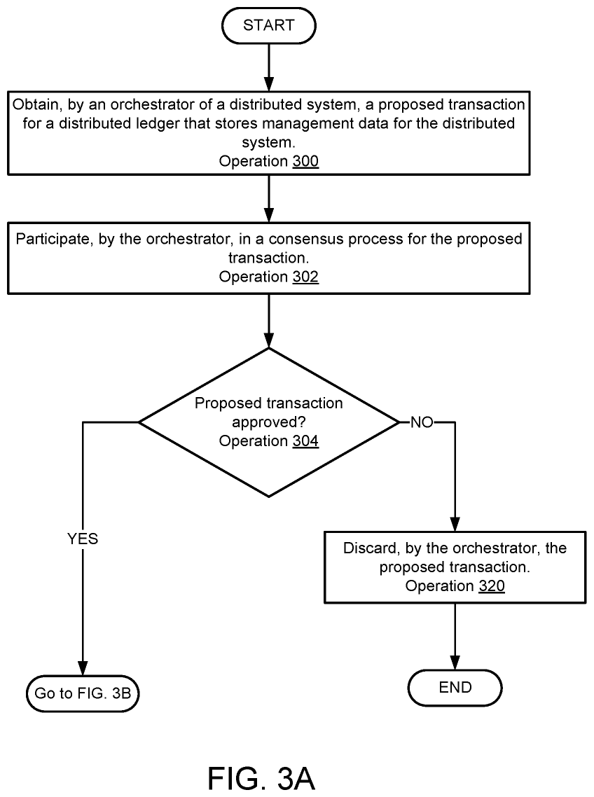

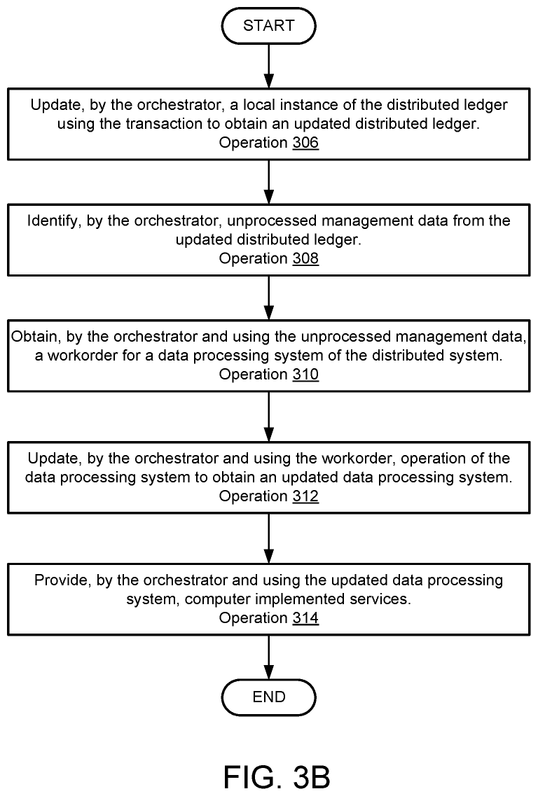

When providing their functionality, any of deployment manager 100 and deployments 110 may perform all, or a portion, of the interactions, processes, and methods illustrated in FIGS. 2B-3B.

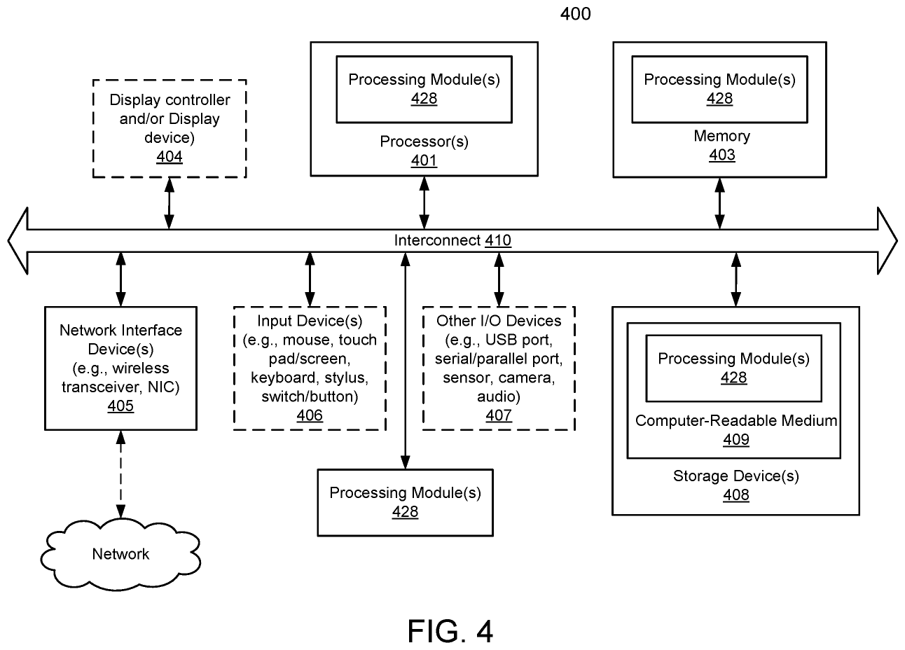

Any of deployment manager 100 and deployments 110 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 120. In an embodiment, communication system 120 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

As discussed above, deployments 110 of the system of FIG. 1 may include any number of data processing systems (DPSs) and/or other types of components that my take on different roles.

Turning to FIG. 2A, a diagram of an example arrangement of DPSs in accordance with an embodiment is shown. In FIG. 2A, DPSs (e.g., 220-244) may be allocated for performance of different roles (e.g., 250, 252). In FIG. 2A, some DPSs are groups into orchestration groups (e.g., 200-206). The orchestration groups may be portions of the DPSs that are managed by a DPS that has taken on an orchestrator role, while the remaining DPSs of the orchestration group may have taken on a member role. In the example topology shown in FIG. 2A, three orchestration groups with a limited number of member DPSs are shown. However, it will be appreciated that a distributed system in accordance with an embodiment may included different numbers of orchestration groups, and each orchestration group may include any number, and similar or different numbers of DPSs.

The roles of the DPSs may be assigned to manage the operation of the DPSs. For example, some data processing systems (e.g., 222, 224, 234, 232, 242, 244) may be assigned to perform an orchestrator role (e.g., 250). The orchestrator role may cause the data processing system to take on management responsibility for an orchestration group (e.g., 200, 202, 206, logical groups of data processing systems). When assigned the orchestrator role, a data processing system (DPS) (e.g., 220, 230, 240) may be tasked with deciding how to modify operation of other DPSs in an orchestration group, manage the distributed ledger (or at least a hosted instance of the distributed ledger), and using automation frameworks (e.g., by sending workorder to agents hosted by other DPSs) to update operation of managed DPSs.

The managed DPSs (e.g., 222, 224) of an orchestration group (e.g., 200) may take on a member role (e.g., 252). When assigned the member role, a DPS may be tasked with (i) obtaining information regarding its condition (e.g., configurations, hardware component loadout, condition of the hardware/software components, errors/anomalous operation, etc.) and environmental conditions (e.g., physical such as temperature, network such as connectivity to other devices, and/or other types of conditions impacting the DPS), (ii) cooperatively updating the distribute ledger based on the obtained information (e.g., by providing it to an orchestrator which may attempt to add it as part of an update such as a block to the distribute ledger which may be a block chain), and (iii) updating their operation based on workorders and/or other information obtained from orchestrators. Additionally, the managed DPSs may also retain copies of the distribute ledger so that if the role of the DPSs change to that of an orchestrator role, the DPSs may already have access to information on which to make future management decisions for components of the distributed system.

Thus, the disclosed system may, in accordance with an embodiment, dynamically update its operation based on changing conditions and states of devices.

To further clarify embodiments disclosed herein, data flow diagrams in accordance with an embodiment are shown in FIGS. 2B-2C. In these diagrams, flows of data and processing of data are illustrated using different sets of shapes. A first set of shapes (e.g., 260, 268, etc.) is used to represent data structures, a second set of shapes (e.g., 262, 270, etc.) is used to represent processes performed using and/or that generate data, and a third set of shapes (e.g., 264, 266, etc.) is used to represent large scale data structures such as databases.

Turning to FIG. 2B, a first data flow diagram in accordance with an embodiment is shown. The first data flow diagram may illustrate data used in and data processing performed in maintaining an instance of a distributed ledger.

To maintain a distribute ledger, a proposed transaction (e.g., 260) for the distributed ledger may be obtained. The proposed transaction may be obtained by reading it from storage, obtaining it from another device (e.g., another device may generate it), generating it, and/or via other methods. The proposed transaction may be generated if an orchestrator (e.g., a data processing system performing the orchestrator role) identifies (i) a change to a condition of a managed DPS (e.g., the DPS may manage and report its condition, and/or the orchestrator may actively investigate the conditions of managed DPSs), (ii) a need (e.g., failure of another orchestrator) to update management of the DPSs, and/or (iii) a need (e.g., change in condition) to update operation (e.g., change configuration, remote/add software, etc.) of a managed DPS.

Once obtained, proposed transaction 260 may be ingested by consensus process 262. Consensus process 262 may be a local instance of a distributed process performed by orchestrators (e.g., are afforded the right to vote based on their proof of stake) to decide whether proposed transaction 260 should be used to update the distribute ledger. During consensus process 262, (i) an orchestrator may use its local information to decide whether proposed transaction 260 should be approved for use in updating the distribute ledger, (ii) case a vote corresponding to the decision made by the orchestrator, (iii) receive votes from other orchestrators usable to identify whether proposed transaction 260 is approved thereby obtaining decision 268.

To make its own determination, the content of proposed transaction 260 may be compared to the content of the distributed ledger (e.g., using a local copy of it stored as distributed ledger instance 264), local data 266 (e.g., local information obtained by an orchestrator that is not part of the distribute ledger), and policies (not shown) that define information to be used to update the distributed ledger. The policies may include rules and/or other criteria that define whether information is to be used to update the distributed ledger. The rules may set quality levels for the information, content of the information, and/or other characteristics of the information to take into account when deciding whether to update the distributed ledger based on the information.

In this example, the orchestrator may have been selected to cast a vote for proposed transaction. However, it will be appreciated that a voting system used in consensus process 262 may select a subset of the orchestrators to cast votes. The subset may be selected using various processes to cause different subsets to vote for different proposed transactions. Consequently, if any of the orchestrators are compromised, the compromised orchestrators may not be allowed to cast votes for all transactions.

Once the votes are casts, copies of the votes may be sent to each orchestrator to enable each orchestrator to independently verify whether proposed transaction 260 is to be used to update the distributed ledger, and through which decision 268 is obtained.

If decision 268 is in the affirmative, then update process 270 (the box and lines leading to the box representing update process is drawn in dashing to indicate that it may not be performed if decision 268 is in the negative) may be performed. During update process 270, distributed ledger instance 264 is updated using proposed transaction 260. The information included in proposed transaction 260 may be used to update distributed ledger instance 264 in an immutable and verifiable fashion.

Thus, using the flow shown in FIG. 2B, a distributed ledger may be updated overtime in a manner that reduces the likelihood of compromised devices tainting the content of the distributed ledger.

Turning to FIG. 2C, a second data flow diagram in accordance with an embodiment is shown. The second data flow diagram may illustrate data used in and data processing performed in management of data processing system.

To manage data processing systems (e.g., that have taken on member roles), the content of distributed ledger instance 264 may be monitored over time to identify changes in conditions of data processing systems (e.g., managed DPSs) and management actions previously performed on the data processing systems. This information (e.g., management data) may be obtained and used in management process 280 to obtain workorder 282.

During management process 280, the condition of a data processing system and previously performed management actions may be reviewed based on various management policies (e.g., 281) for managing DPSs. The management policies may identify management actions to be performed when certain conditions are met such as when the DPS has certain conditions and/or certain management actions have been previously performed. The management policies may be defined by subject matter experts and/or via other methods.

Workorder 282 may be generated based on the management actions identified using the management policies and management data. Workorder 282 may be a signed request for performance of the management actions by a data processing system.

Once obtained, workorder 282 may be ingested by operation update process 284 (e.g., a part of an automation framework used to update operation of the DPS). During operation update process 284, a data processing system may verify workorder 282 using the signature and, once verified that the orchestrator is trusted and has sufficient authority to issue the workorder, may initiate performance of the management actions specified by workorder 282. In this manner the operation of the DPS may be updated.

While described with respect to updating the operation of a member DPS, similar activity may be performed to operate management of any number of DPSs. For example, if distributed ledger instance 264 indicates that another orchestrator is offline, then management process 280 may identify that the orchestrator is to take over management authority over the DPSs managed by the other orchestrator. The resulting workorder may, in this example, cause the DPSs to joint the orchestration group managed by the orchestrator. Thus, the orchestrator may take over authority for these additional DPSs. However, because the orchestrator has a consistent view of the distributed system with other orchestrators and may implement similar management policies (e.g., 281), the authority takeover may be nearly seamless once the additional DPSs join the orchestration group.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage operation of infrastructure dynamic resource allocation to address processing bottlenecks. FIGS. 3A-3B illustrate methods that may be performed by the components of the system of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method for managing operation of a distributed system in accordance with an embodiment is shown. The method may be performed by any of deployment manager 100, deployments 110, and/or other components of the system shown in FIG. 1.

At operation 300, a proposed transaction for a distributed ledger that stores management data for a distribute system may be obtained by an orchestrator of the distributed system. The proposed transaction may be obtained by reading it from storage, receiving it from another device, by generating it, and/or via other methods.

At operation 302, the orchestrator may participate in a consensus process for the proposed transaction. The orchestrator may participate by (i) if selected to participate actively, review the proposed transaction in view of policies that discriminate information to be used to update the distributed ledger from other information, (ii) cast a vote for or against the proposed transaction, and (iii) obtain votes (e.g., from other orchestrators) that define whether the proposed transaction is acceptable. The votes may be compared to thresholds or other types of criteria that discriminate acceptable from unacceptable proposed transactions. For example, a majority of positive votes for acceptability of the proposed transaction may be needed for the proposed transaction to be acceptable.

At operation 304, a determination may be made regarding whether the proposed transaction is approved. The proposed transaction may be approved if sufficient positive votes are cast for it.

If the proposed transaction is acceptable, then the method may proceed to operation 306 shown in FIG. 3B. Otherwise, the method may proceed to operation 320.

At operation 320, the proposed transaction is discarded by the orchestrator. The proposed transaction may be discarded by deleting it without updating a local instance of the distributed ledger using the proposed transaction.

The method may end following operation 320.

Returning to operation 304, the method may proceed to operation 306 following operation 304 when the proposed transaction is approved.

Turning to FIG. 3B, a second flow diagram in accordance with an embodiment is shown. The second flow diagram may be a continuation of the first flow diagram.

At operation 306, a local instance of the distributed ledger is updated by the orchestrator using the transaction to obtain an updated distribute ledger. The local instance may be updated by modifying the local instance based on the content of the proposed transaction.

At operation 308, unprocessed management data (e.g., newly added by the proposed transaction) from the updated distributed ledger may be identified by the orchestrator. The unprocessed management data may be identified by identifying changes made to the instance of the distribute ledger in operation 306, and/or via other methods.

At operation 310, a workorder for a data processing system of the distributed system is obtained by the orchestrator using the unprocessed management data. The workorder may be obtained by reviewing the unprocessed management data in view of policies that define management action in view of the content of the instance of the distributed ledger. The policies may define management actions which may be used to generate the workorder. For example, the management actions specified by the policies based on the condition of the data processing system may be aggregated in the workorder. The aggregated management actions may be signed (e.g., using a private key maintained by the orchestrator and verifiable using a public key) to obtain the workorder.

At operation 312, operation of the distributed system is updated by the orchestrator using the workorder to obtain an updated data processing system, the updated data processing system thereby updating operation of the distributed system. The operation may be updated by providing the workorder to an automation engine hosted in part by the data processing system. The automation engine may execute the workorder thereby causing the management actions to be performed.

At operation 314, computer implemented services are provided by the orchestrator using the updated data processing system. For example, the updated operation of the updated data processing system may provide the computer implemented services on behalf of the orchestrator that managed the updated data processing system.

The method may end following operation 314.

Thus, using the methods shown in FIGS. 3A-3B, embodiments disclosed herein may facilitate management of data processing systems of distributed systems.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing resources of a distributed system, the method comprising:
obtaining, by an orchestrator of the distributed, a proposed transaction for a distributed ledger that stores management data for the distributed system;
participating, by the orchestrator, in a consensus process for the proposed transaction;
in an instance of the participating where the proposed transaction is approved by orchestrators of the distributed system:
updating, by the orchestrator, a local instance of the distributed ledger using the transaction to obtain an updated distributed ledger;
identifying, by the orchestrator, unprocessed management data from the updated distributed ledger;
obtaining, by the orchestrator and using the unprocessed management data, a workorder for a data processing system for the distributed system;
updating, by the orchestrator and using the workorder, operation of the data processing system to obtain an updated data processing system; and
providing, by the orchestrator and using the updated data processing system, computer implemented services.

2. The method of claim 1, wherein the consensus process is a blockchain process that utilizes a proof of stake mechanism for management of the distributed ledger.

3. The method of claim 2, wherein the proof of stake mechanism selects at least a portion of the orchestrators to vote on the proposed transaction.

4. The method of claim 3, wherein votes cast by the portion of the orchestrators are used to identify whether the orchestrators approved the proposed transaction.

5. The method of claim 3, wherein the portion of the orchestrators is selected at random from orchestrators, and the portion of the orchestrators is at least a majority of the orchestrators.

6. The method of claim 1, wherein the proposed transaction indicates reassignment of management of the data processing system from another orchestrator of the orchestrators to the orchestrator for management purposes.

7. The method of claim 1, wherein the proposed transaction indicates a change in condition of the data processing system.

8. The method of claim 1, wherein the distributed system comprises data processing systems comprising the data processing system, and each of the orchestrators is tasked with managing a subset of the data processing systems.

9. The method of claim 8, wherein each of the orchestrators maintains a separate local instance of the distributed ledger.

10. The method of claim 9, wherein each of the separate local instances of the distributed ledger are eventually consistent with each other, and each of the local instances of the distributed ledger comprises first data reflecting a condition of each data processing system of the distributed system and management assignments for the orchestrators, the management assignments indicating the subset of the data processing systems each orchestrator is tasked with managing.

11. A non-transitory machine-readable medium having instructions stored therein, which when executed by a processor, cause operations for managing resources of a distributed system, the operations comprising:
obtaining, by an orchestrator of the distributed, a proposed transaction for a distributed ledger that stores management data for the distributed system;
participating, by the orchestrator, in a consensus process for the proposed transaction;
in an instance of the participating where the proposed transaction is approved by orchestrators of the distributed system:
updating, by the orchestrator, a local instance of the distributed ledger using the transaction to obtain an updated distributed ledger;
identifying, by the orchestrator, unprocessed management data from the updated distributed ledger;
obtaining, by the orchestrator and using the unprocessed management data, a workorder for a data processing system for the distributed system;
updating, by the orchestrator and using the workorder, operation of the data processing system to obtain an updated data processing system; and
providing, by the orchestrator and using the updated data processing system, computer implemented services.

12. The non-transitory machine-readable medium of claim 11, wherein the consensus process is a blockchain process that utilizes a proof of stake mechanism for management of the distributed ledger.

13. The non-transitory machine-readable medium of claim 12, wherein the proof of stake mechanism selects at least a portion of the orchestrators to vote on the proposed transaction.

14. The non-transitory machine-readable medium of claim 13, wherein votes cast by the portion of the orchestrators are used to identify whether the orchestrators approved the proposed transaction.

15. The non-transitory machine-readable medium of claim 13, wherein the portion of the orchestrators is selected at random from orchestrators, and the portion of the orchestrators is at least a majority of the orchestrators.

16. An orchestrator, comprising:
a processor; and
a memory coupled to the processor to store instructions, which when executed by the processor, cause operations for managing resources of a distributed system, the operations comprising:
obtaining a proposed transaction for a distributed ledger that stores management data for the distributed system;
participating in a consensus process for the proposed transaction;
in an instance of the participating where the proposed transaction is approved by orchestrators of the distributed system:
updating a local instance of the distributed ledger using the transaction to obtain an updated distributed ledger;
identifying unprocessed management data from the updated distributed ledger;
obtaining, using the unprocessed management data, a workorder for a data processing system for the distributed system;
updating, sing the workorder, operation of the data processing system to obtain an updated data processing system; and
providing, using the updated data processing system, computer implemented services.

17. The orchestrator of claim 16, wherein the consensus process is a blockchain process that utilizes a proof of stake mechanism for management of the distributed ledger.

18. The orchestrator of claim 17, wherein the proof of stake mechanism selects at least a portion of the orchestrators to vote on the proposed transaction.

19. The orchestrator of claim 18, wherein votes cast by the portion of the orchestrators are used to identify whether the orchestrators approved the proposed transaction.

20. The orchestrator of claim 18, wherein the portion of the orchestrators is selected at random from orchestrators, and the portion of the orchestrators is at least a majority of the orchestrators.
